(19) United States
(12) Patent Application Publication
(10) Pub. No.: US 2013/0308090 A1
(43) Pub. Date: Nov. 21, 2013

(54) PROTECTIVE LENS FOR VISION CORRECTION

(71) Applicant: CHIN-JEN CHEN, TAINAN CITY (TW)

(72) Inventor: CHIN-JEN CHEN, TAINAN CITY (TW)

(21) Appl. No.: 13/866,230

(22) Filed: Apr. 19, 2013

(30) Foreign Application Priority Data
May 21, 2012 (TW) 101209554

(51) Int. Cl. G02C 7/02

(52) U.S. Cl. CPC G02C 7/02
USPC 351/159.01

(57) ABSTRACT

A protective lens for vision correction is revealed. The protective lens for vision correction includes a plano lens area and an optical lens area. The optical lens area is a round area whose diameter ranging from 3 cm to 5 cm. After the protective lens being cut and mounted in an eyeglass frame, the optical lens area is corresponding to eyes of users. The optical lens area is a concave lens or a convex lens. Thereby users with vision correction needs can wear the protective lens for vision correction conveniently and the protective lens with vision correction function is easy to use.

### BACKGROUND OF THE INVENTION

1. Field of the Invention

The present invention relates to a protective lens for vision correction, especially to a protective lens disposed with an area for vision correction. Thus the protective lens is provided to those in need of vision correction.

2. Description of Related Art

When consumers with vision correction needs wear a protective eyewear 2 during exercise or work, the protective eyewear 2 is settled against their face, directly over a corrective eyewear 1, as shown in FIG. 1. The protective eyewear 2 completely covers the corrective eyewear 1 and the corrective eyewear 1 is located in the protective eyewear 2. However, in such use mode, the user needs to wear two pairs of eyewear-the corrective eyewear 1 and the protective eyewear 2 at the same time. This is quite uncomfortable. While not in use, the protective eyewear 2 is taken off for storage. Thus such design is inconvenient and trouble in use and storage. Moreover, the user needs to buy both the corrective eyewear 1 and the protective eyewear 2 with plano lenses. Thus the cost spent on the eyewear is high.

Refer to FIG. 2, in order to solve the above problem, an eyeglass frame 5 assembled with an optical lens frame 3 and a protective lens frame 4 simultaneously has been invented and provided. A first connection slot 51 and a second connection slot 52 are mounted in the eyeglass frame 5, parallel to each other. The first connection slot 51 is used to mount the optical lens frame 3 while the second connection slot 52 is assembled with the protective lens frame 4. Thus the user can directly set the protective lens frame 4 in the eyeglass frame 5 assembled with optical lenses. He or she doesn't need to purchase another protective eyewear. A burden on the cost of the eyewear can be decreased. However, the design still has shortcomings of easy loss of components while being disassembled for storage.

In order to overcome the above shortcomings, there is a need to provide a novel protective lens.

### SUMMARY OF THE INVENTION

Therefore it is a primary object of the present invention to provide a protective lens for vision correction that not only protects users' eyes but also has the function of vision correction. For users need vision correction, they feel more comfortable and convenient while wearing a pair of goggles with the protective lenses of the present invention. Moreover, the cost they spent on eyeglasses and the goggles can be reduced.

In order to achieve above object, a protective lens for vision correction according to the present invention consists of a plano lens area and an optical lens area. The optical lens area is a round area whose diameter ranging from 3 cm to 5 cm. The optical lens area is corresponding to user's eyes on the face after the protective lens being cut and mounted in an eyeglass frame. The optical lens area is a concave lens or a convex lens.

Thereby the protective lens not only safeguards user's eyes but also provides the function of vision correction after the protective lens for vision correction being cut and assembled on the eyeglass frame. Thus the user with vision correction needs can wear the protective lens for vision correction conveniently and the protective lens for vision correction is easy to use.

Furthermore, the protective lens of the present invention also provides the vision correction function. Thus there is no need for users to wear a corrective eyewear while wearing a protective eyewear. The burden on the cost of the eyewear can be reduced.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a schematic drawing showing a user wearing a corrective eyewear and a protective eyewear at the same time;

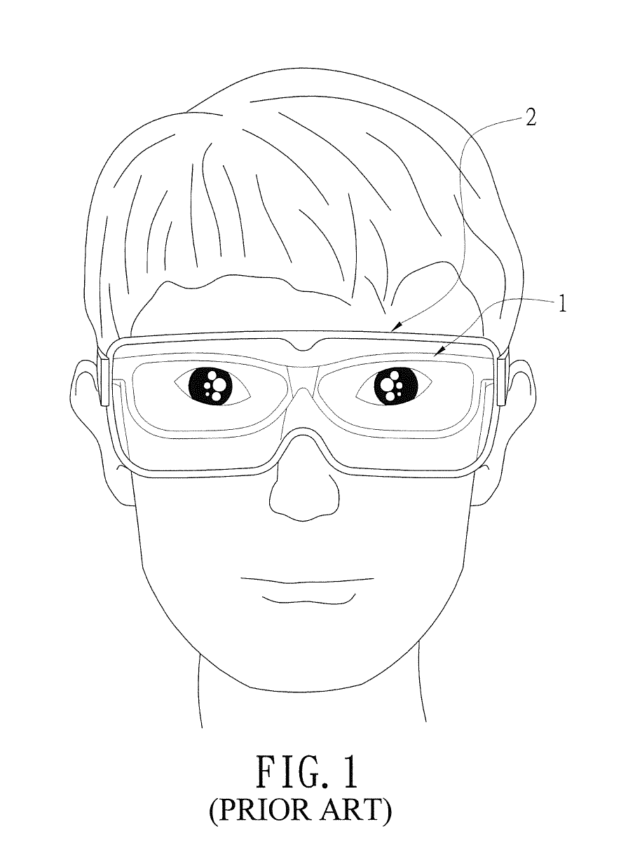

FIG. 2 is an explosive view of a conventional eyewear frame having an optical lens frame and a protective lens frame;

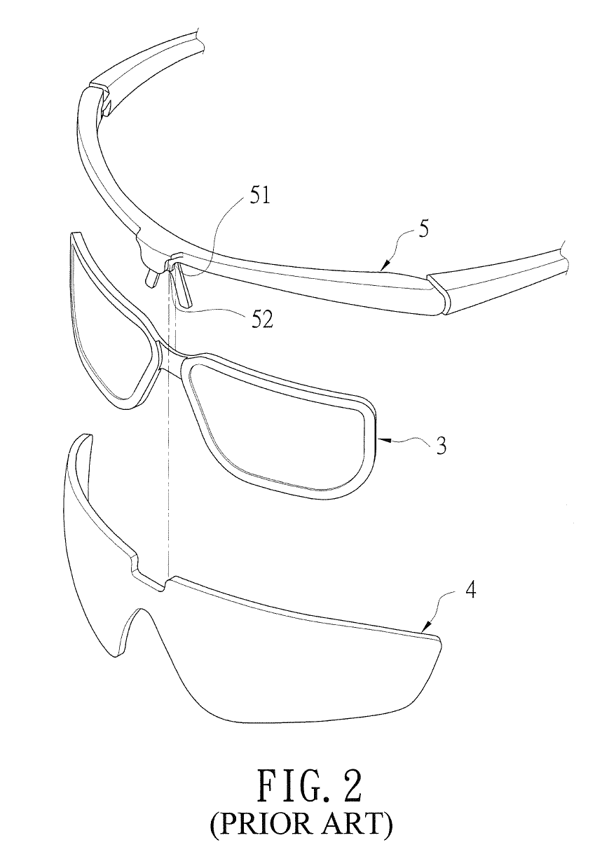

FIG. 3 is a perspective view of an embodiment of a protective lens for vision correction according to the present invention;

FIG. 4 is a perspective view of an embodiment of a protective lens for vision correction being cut and mounted in an eyeglass frame according to the present invention;

FIG. 5 is a schematic drawing showing a user wearing an eyewear assembled with protective lenses for vision correction according to the present invention.

### DETAILED DESCRIPTION OF THE PREFERRED EMBODIMENT

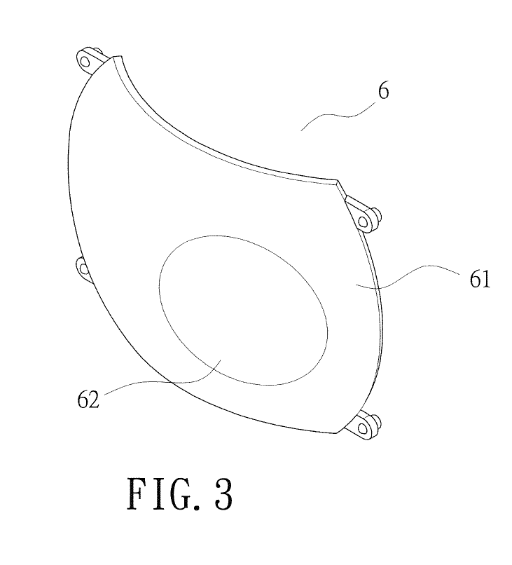

Refer to FIG. 3, a perspective view of an embodiment of a protective lens 6 for vision correction is revealed. The protective lens 6 for vision correction includes a plano lens area 61 and an optical lens area 62. The optical lens area 62 is located on an inner area of the protective lens 6 while the plano lens area 61 is arranged around the optical lens area 62.

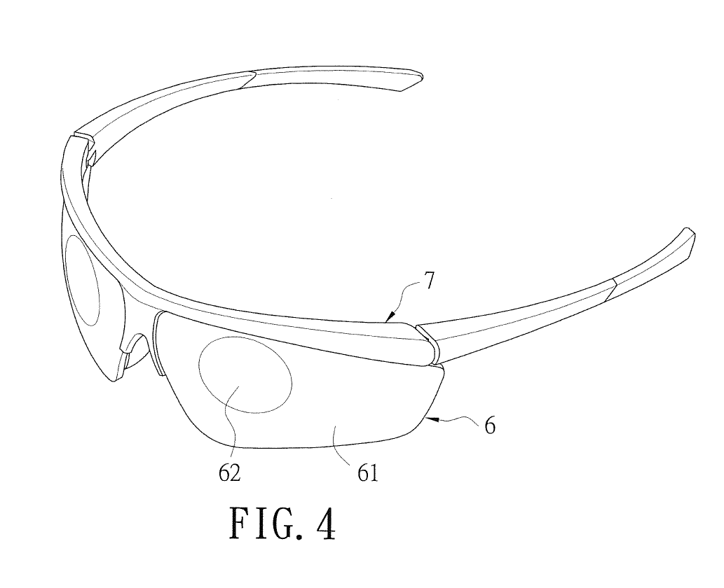

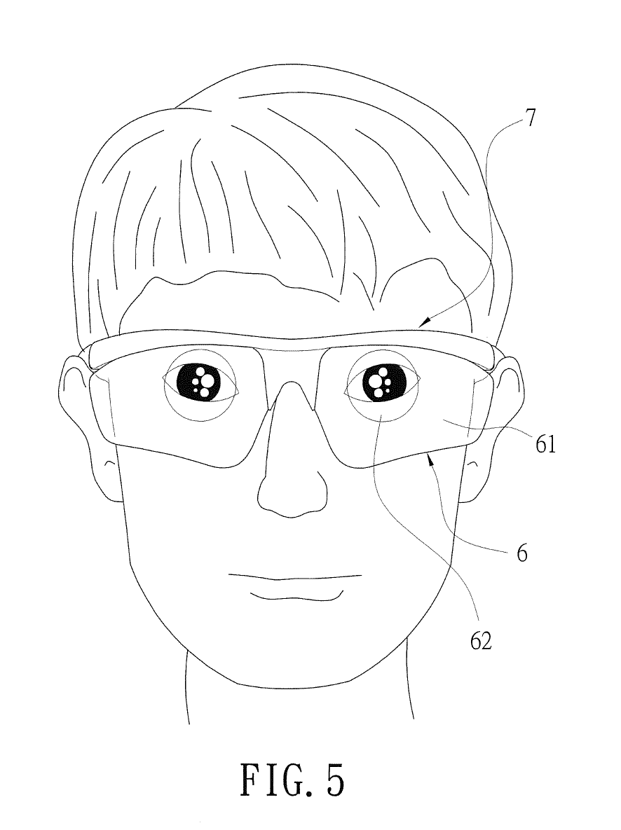

The protective lens 6 is cut according to the shape of an eyeglass frame 7 and then is assembled with the eyeglass frame 7, as shown in FIG. 4. When the user is wearing the eyeglass frame 7, the protective lens 6 is just located at the position corresponding to eyes on the user's face, as shown in FIG. 5.

In a preferred embodiment of the protective lens 6 for vision correction according to the present invention, the optical lens area 62 is a concave lens.

In a preferred embodiment of the protective lens 6 for vision correction according to the present invention, the optical lens area 62 is a convex lens.

In a preferred embodiment of the protective lens 6 for vision correction according to the present invention, the optical lens area 62 is a round area whose diameter ranging from 3 centimeters to 5 centimeters.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A protective lens for vision correction comprising a plano lens area and an optical lens area; the optical lens area is located inside the protective lens while the plano lens area is located around the optical lens area; the optical lens area is corresponding to users' eyes on face after the protective lens being cut, assembled with an eyeglass frame and worn by users.

2. The device as claimed in claim 1, wherein the optical lens area is a concave lens.

3. The device as claimed in claim 2, wherein the optical lens area is a round area whose diameter ranges from 3 centimeters to 5 centimeters.

4. The device as claimed in claim 1, wherein the optical lens area is a convex lens.

5. The device as claimed in claim 4, wherein the optical lens area is a round area whose diameter ranges from 3 centimeters to 5 centimeters.

6. The device as claimed in claim 1, wherein the optical lens area is a round area whose diameter ranges from 3 centimeters to 5 centimeters.
